(19) United States
(12) Patent Application Publication
(10) Pub. No.: US 2016/0337456 A1
(43) Pub. Date: Nov. 17, 2016

(54) PROBABILISTIC FEDERATED AGENT DISCOVERY FOR PERVASIVE DEVICE MANAGEMENT SYSTEM

(71) Applicant: Agreeya Mobility, Inc., Mountain View, CA (US)

(72) Inventors: Chirag Pathak, Burnaby (CA); Ashwini Bharadwaj, Burnaby (CA); Bernard Wei, Burnaby (CA); Thomas Winkler, Burnaby (CA); Daniel Qiu, Burnaby (CA); Pankaj Thapa, Mountain View, CA (US); Amonn Phillip, Burnaby (CA); Amey Kulkarni, Burnaby (CA); Julius Liu, Burnaby (CA)

(21) Appl. No.: 14/711,479

(22) Filed: May 13, 2015

(51) Int. Cl. H04L 29/08

(52) U.S. Cl. CPC H04L 67/16; H04L 67/18

(57) ABSTRACT

The embodiments herein disclose a system and method for federated service agent discovery in a pervasive device management system. The method includes receiving, by a discovery agent in a society, a request from a user agent for discovering a location of a service agent in the society. Further, the method includes discovering, by the discovery agent, the location of the service agent in the society to establish a connection between the user agent and the service agent, wherein the location of the service agent is federately discovered by the discovery agent by communicating with other discovery agents in the society.

### TECHNICAL FIELD

The embodiments herein relate to pervasive device management system, and more particularly related to a mechanism for federated service agent discovery in the pervasive device management system.

### BACKGROUND

Pervasive computing or ubiquitous computing is a growing trend towards embedding microprocessors in objects, which can collect information, communicate information and process information to take action. Pervasiveness is because the computing systems have entered the day to day fabric of life and behaviors, which were not computing aware earlier. Examples of the pervasive computing systems can include but are not limited to smart meters, smart cars, wearable devices, smart phones with pervasive applications, smart homes, and the like. This pervasiveness has become popular due to availability of cloud platform service, communication technology development and context aware applications. The pervasive computing model has basically four components: devices (For example: smart phones and meters and the like), pervasive network (For example: internet over cellular and Wi-Fi networks), pervasive middleware (For example: Android operating system, Cloud platforms like Software as a Service (SaaS), Infrastructure as a service (IaaS) and Platform as a service (PaaS)), and pervasive applications (For example: many SaaS and non-SaaS applications). There are several challenges faced for using the pervasive computing system in everyday life.

Scalability: The exponential proliferation of users, applications, networked devices and their interactions poses unique scalability challenge. To combat the exponential proliferation, device independent and cloud based software may be used.

Heterogeneity: Differences among many heterogeneous platforms (physical and logical) may need to be masked (or conditioned) from users. Common and extensible collaboration language may be one of the solutions to address the problem.

Integration: Integrating pervasive components in a single platform poses severe challenges in area of security, Quality of Service (QoS) and reliability. Enterprise service bus, message routing, federated identity and authorization management may be some of the ways to address integration related challenges.

Invisibility: Minimum human intervention is key ingredient of pervasiveness. Human intervention may be required only for defining policies that govern the system (or ecosystem). Systems that can act as user proxy, auto configuring systems (reactive or proactive), etc. are some of the ways to achieve this.

Context awareness and Management: A Proactive and reactive environment monitoring and context awareness is required for pervasive computing to work. There may be several security implications such as privacy and intrusion associated which may be need monitoring. Thus smart management of such monitoring is very important. A rule based management system that provides common operational picture may be used for smart management of the monitoring.

Device Management Systems: With the evolution of mobile computing, the organizations (e.g. enterprises, operators, government organizations) that use and run the elements of mobile computing infrastructure (e.g. physical mobile devices, virtualized mobile devices, software resources and infrastructure resources) need to manage and configure them in an effective way. In conventional mechanisms, mobile device management involves a centralized device management system operated by the owner of the devices being managed, and device management agents embedded into or installed onto those devices. Device Management System is by nature a pervasive computing system.

In conventional systems, the devices themselves may be capable of hosting smart applications, which can be portal to services in the Internet or they can be services themselves. These devices may or may not be human interactive devices. There is a need for a discovery solution in device management system that can connect software agents, in mobile or fixed devices and services, to each other.

The above information is presented as background information only to help the reader to understand the present invention. Applicants have made no determination and make no assertion as to whether any of the above might be applicable as Prior Art with regard to the present application.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1a illustrates generally, among other things, a high level overview of a pervasive device management system for federated service agent discovery, according to embodiments disclosed herein;

FIG. 1b illustrates example relationships between the agents, according to embodiments as disclosed herein;

FIG. 2 is a sequence diagram illustrating for federated service agent discovery in the pervasive device management system, according to embodiments disclosed herein;

FIG. 3 is a flow diagram illustrating a method for federated service agent discovery in the pervasive device management system, according to embodiments as disclosed herein;

FIG. 4 shows example illustrations for Mobile Enterprise Stack Device Management (MES DM) services region specific registries and agents, according to embodiments as disclosed herein; and

FIG. 5 is a computing environment for implementing the system and method described herein, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

The W3C Web Service architecture: Describes the two ways in which service requesting agent like for example a user Agent and service providing agent like for example a service Agent can connect with each other. A Push based mechanism by which the provider makes it known to the requestor and service discovery mechanism by which the requestor can know about the provider. However, even in the push based scenario the provider needs to discover (if they do not know each other) the requestor i.e. identification is not shared or not trusted. This disclosure provides a discovery service that can be used in various embodiments as described herein.

Mobile Enterprise Stack System Device Management Service: It is an enterprise centric device management service, which is based on the W3C web service architecture and it is a pervasive computing system. Thus, the Mobile Enterprise Stack System Device Management Service requires being globally distributed, heterogonous, very scalable and integrated. To ensure the service solution providing federated registry service is required, which can be scalable (and space efficient), secure flexible.

The term “Mobile Enterprise Stack System” refers to a system consisting of several elements as described in parts of this document. The relevant parts of the Mobile Enterprise Stack software that are essential to capture the invention are described in the embodiments.

The term “Mobile Enterprise Stack System Instance” refers to a particular installation of the Mobile Enterprise Stack System which can be managed by a Mobile Enterprise Stack System Operator to manage a set of entities and to provide services to a set of customers.

The term “Mobile Enterprise Stack System Operator” refers to a company or an organization that sets up the Mobile Enterprise Stack System Instance to offer services. The Mobile Enterprise Stack System Operator can control all the aspects of the particular Mobile Enterprise Stack System Instance.

The term “Mobile Device Management” refers to the process of managing the configuration and status of mobile devices (including device management, configuration management, application management and the management of other aspects) according to prescribed rules and policies of the organization (e.g. enterprise, government or non-government organization) that owns the managed resources or is entrusted with their management.

The term “Mobile Device Management System” (MDM System) refers to a system that performs Mobile Device Management Tasks.

The term “Enterprise” refers not only to an organization like an enterprise, but also to any entity intending to perform Mobile Device Management Tasks. The entities can include but are not limited to government organization, a non-government organization, service provider, and individual.

The term “Enterprise IT Admin” refers to an authorized individual working as information technology (IT) administrator for an Enterprise, performing the Device Management tasks, such as configuring and administering enterprise services and infrastructure.

The term “Operator Admin” refers to an authorized individual working as administrator of the Mobile Enterprise Stack System Instance.

The term “End User” refers to an employee or associate of the Enterprise, who can be an end user of the enterprise systems (and of the Mobile Enterprise Stack System).

The term “Tenant” may refer to an Enterprise, but using the term “Tenant” refers to the fact that the Mobile Enterprise Stack System is a multi-tenant system, where multiple enterprises can use the system without interference.

The term “Managed Entity” refers to a mobile or stationary device or resource (such as PC, router, connected device, virtual device) which can be connected temporarily or permanently to a mobile network and which the Mobile Enterprise Stack system or the MDM System intends to manage.

The term Device “An individual device” includes but is not limited to a mobile phone, tablet or other device that is connected to the Mobile Enterprise Stack System. The term individual device may be synonymously used with Managed Entity, although the Device refers to a physical device, whereas a managed entity can include virtual devices or other resources, hence the term Managed Entity is more generic.

The term “Mobile Enterprise Stack-enabled device” refers to a mobile or stationary device, virtualized device, or other resource that has been enhanced by Mobile Enterprise Stack device technique.

The term “Third-Party MDM System” refers to an MDM system developed by a third-party, as commonly offered on the market and integrated into the Mobile Enterprise Stack system.

The term “Mobile Enterprise Stack MDM Service” refers to a light-weight MDM system that is part of the Mobile Enterprise Stack system and can be used as alternative or in conjunction with a third-party MDM system.

The term “Mobile Enterprise Stack Workspace” refers to a virtualized, securely isolated area on the device.

The term “Bring Your Own Device” (BYOD) refers to a way of working and a set of enterprise policies that allow enterprise employees (End Users) to use a device they personally own when accessing the enterprises resources. The End User device may need to accept and follow certain policies, or as long as the End User permits the enterprise to directly manage the parts of their device that connect to the enterprise services, hence aiding the adherence to the policies.

The term “Mobile Enterprise Stack Device Client” (MES DM GW Client) refers to a client (agent) running on each device that is connected to a Mobile Enterprise Stack Cloud service, which facilitates the creation and management of the Mobile Enterprise Stack Workspaces via a Mobile Enterprise Stack Gateway.

The term “Mobile Enterprise Stack Device MDM Framework” refers to a subsystem of device-side services and components which can allow for the local management of the Mobile Enterprise Stack workspace by the MDM. By default; this can be used by the Mobile Enterprise Stack Device Client to manage one or more Mobile Enterprise Stack Workspaces on the device. As an exception, a native local MDM client may also use this framework to manage the Mobile Enterprise Stack workspace that is not connected to the Mobile Enterprise Stack Gateway.

The term “Mobile Enterprise Stack Gateway” refers to a service that is part of the Mobile Enterprise Stack System, residing in the cloud, which functions as gateway component between the third-party MDM System and the Mobile Enterprise Stack system.

The term “ID Management Provider” refers to a service related to Identity Management, provided by a third-party set up for a given enterprise. In the case of the Mobile Enterprise Stack system, two subsystems are used, an authentication provider and a directory service.

The term “Authentication Provider” refers to a service that can authenticate a user for this enterprise.

The term “Single Sign-On” (SSO) Provider” refers to a specific type of Authentication Provider that offers SSO (Single Sign-On) capability. The SSO provider provides i.e. the capability to maintain a single session of authentication that can be shared by a number of clients (e.g. applications on a device), so that the End User does not have to re-authenticate with every single client.

The term “Directory Service” refers to a service that provides a list of enterprise users, their email addresses, their primary mobile phone numbers, and their groups and so on.

The term “Resource (or Managed Resource)” refers to an individually manageable name-value-pair, which corresponds to a managed item on a device. It can be used to express policies, settings or to query current status information from the device. The Managed Resource can be generalized way for the Mobile Enterprise Stack system to describe, store and communicate Device Management related concepts.

The term “Resource Operation” refers to an operation to change the value of a resource or to query it.

The term “Policy” describes the desired state or desired behavior or a managed entity, which will be enforced by the device management agent on the device. It is expressed as set of resource operations and other meta-data.

The term “Setting” refers to a value that may NOT be enforced. For example, the setting may be changeable by the device, or can be a reflection of the current device status.

The term “Attribute” refers to a policy or setting that can be composed of a set of attributes.

The term “Software as a Service” (SaaS) App refers to an application that uses a “Software as a Service” model and hence connects to the back-end of the Service Provider, and which often requires authentication and authorization to use the service of the service provider, in order to function fully.

The embodiments of the invention relates to the field of device and network management and more particularly to the management of devices (mobile or stationary) and services (physical or virtual) by a central management system (device management system).

The embodiments of the invention relates to field of pervasive computing. The pervasive computing allows performing agent discovery over heterogeneous globally distributed multi-tenant pervasive computer system without requiring user intervention.

This embodiment of the invention relates to in field of web service architecture defined by W3C but it is to be understood that other embodiments are not limited thereon. The W3C provides a discovery service for an agent as opposed to service. Accordingly, the examples should not be construed as limiting the scope of the embodiments herein.

The embodiments herein disclose a system and method for federated service agent discovery in a pervasive device management system. The method includes receiving a request from a user agent for discovering a location of a service agent in at least one society. Further, the method includes discovering the location of the service agent in the society to establish a connection between the user agent and the service agent, wherein the location of the service agent is federately discovered by the discovery agent by communicating with other discovery agents in the society. In an embodiment, the society is formed by the user agent, the discovery agent, the service agent and the connection agent, wherein all the agents are sharing a common ontology. The ontology includes information of at least one of geographic location, enterprise tenancy, service type, choreographies, and trust zone. In an embodiment, the society is composed of other sub-societies.

Unlike the conventional systems, the location of the service agent is federately discovered by the discovery agents in the society. The method allows the discovery agent to determine whether the service agent is available in the society. Further, the method includes forwarding the request to other discovery agent to discover the location of the service agent in the society in response to determining that the service agent is unavailable in the society. Further, the method includes sending the location of the service agent to the user agent to establish the connection with the service agent, wherein the connection between the user agent and the service agent is established by a connection agent of the society in which the service agent is located.

In an embodiment, the connection between the user agent and the service agent is used to communicate with other service agents in the society. In an embodiment, the connection is handed over to support multi agent's support in the society. In another embodiment, the connection is cloned to support multi agent's support in the society.

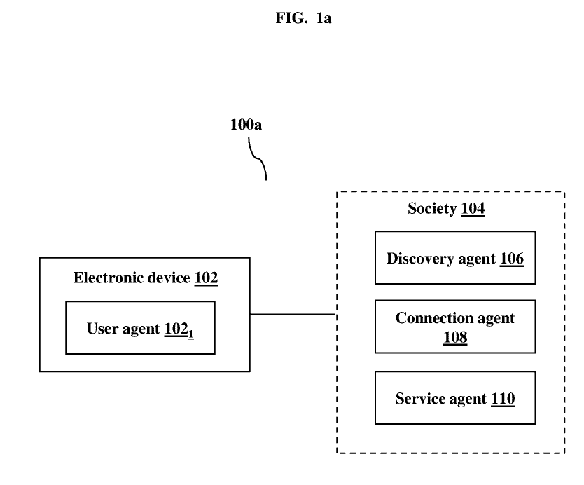

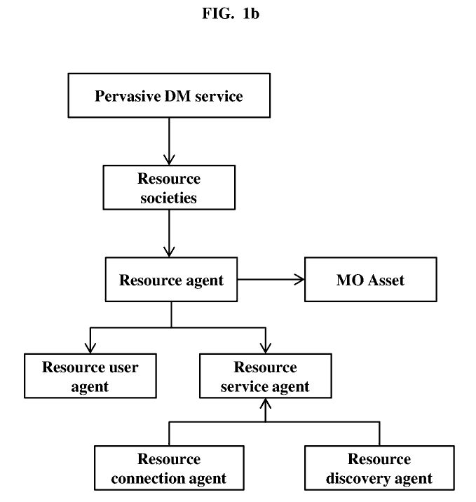

Referring now to the drawings, and more particularly to FIGS. 1 through 5, where similar reference characters denote corresponding features consistently throughout the figures, there are shown embodiments.

FIG. 1a illustrates generally, among other things, a high level overview of a pervasive device management system 100a for federated service agent discovery in a society, according to embodiments disclosed herein. Further, the pervasive device management service can be provided by many software and hardware agents. There can be a group of agents that share common ontologies to form societies. In an embodiment, the group of agents forming the society 104 can be for example, but is not limited to, a discovery agent 106, a connection agent 108, and a service agent 110. In an embodiment, the society 104 can be composed of other sub-societies. In an embodiment, the ontologies can include, but are not limited to, a geographic location, an enterprise tenancy, a service type, choreographies, and a trust zone. Further, example relationships between the agents are described in the FIG. 1b. The various agents communicates with each other for probabilistic federated discovery of service agents in the society.

In an embodiment, the user agent 102₁ can be running or integrated in an electronic device 102 such as, for example but is not limited to, a mobile phone, a mobile station, a smart phone, a Personal Digital Assistants (PDAs), a tablet, a phablet, or any other electronic device. Further, the user agent 102₁ can be configured to use the discovery agent 106 to locate the service agent 110 in the society 104 by sending a request including a Uniform Resource Identifier (URI) of the service agent 110. In an embodiment, there can be more than one society of the service agent 110. Further, the discovery agent 106 can be configured to communicate with the other discovery agents (not shown) to locate the service agent. Once the location of a Uniform Resource location (URL) of the service agent 110 is determined then, the connection agent 108 of the society 104 where the service agent 110 is located can be contacted to enable the remote connection between the user agent 102₁ and the service agent 110. After establishing the connection, the connection can be used for collaborating with any agent in the society 104. In case of distributed agents within the society 104, the connection is handed over or cloned to support multi agent sessions.

FIG. 1a shows a limited number of the system 100a but it is to be understood that other embodiments are not limited thereon. In real-time, the system 100a can include any number of agents belonging to one or more societies along with other components communicating directly, indirectly, or remotely among each other.

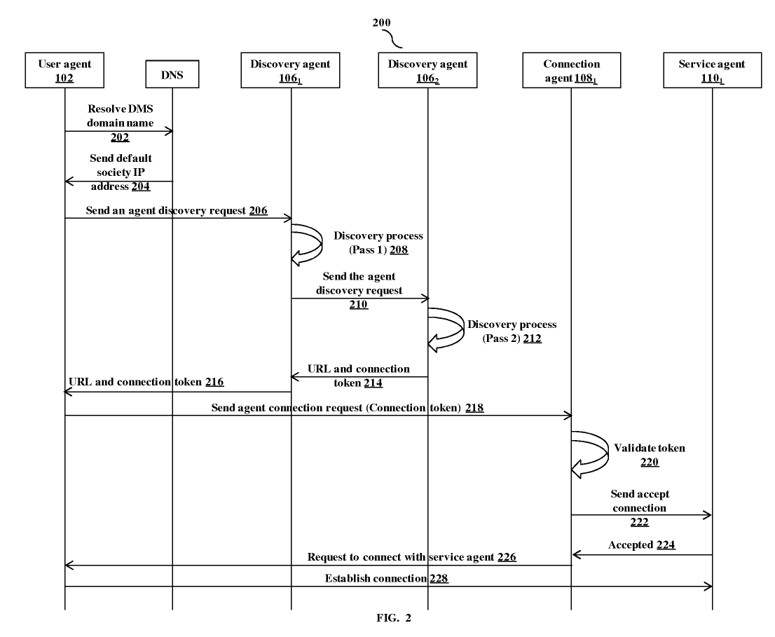

FIG. 2 is a sequence diagram 200 illustrating for federated service agent discovery in the pervasive device management system 100, according to embodiments disclosed herein. In an embodiment at step 202, the user agent 102₁ requests for a default society Internet Protocol (IP) address to a Domain Name System (DNS). At step 204, after receiving the request, the DNS sends the default society IP address to the user agent 102₁.

At step 206, the user agent 102₁ can be configured to send the request to the discovery agent 106₁ in the default society (i.e., society 104) by using the IP address of the default society. In an embodiment, the request is an agent discovery request. In an embodiment, the user agent 102₁ can be configured to send a Hypertext Transfer Protocol (HTTP) agent location discovery request with a Uniform Resource Identifier (URI) identifying the user agent 102₁ and the URI identifying the service agent 110 (i.e., peer agent) to the discovery agent 106₁ in the default society. The default agent society can be a logical universal set of all the agents in the pervasive device management system 100 and all the agents can identify by default. Further, the default society forms the domain authority registered with the DNS in Internet. The society is identified using the domain authority or a URI query.

At step 208, after receiving the request, the discovery agent 106₁ can be configured to normalize the request including the URIs using Uniform Resource Location (URL) normalization rules defined by RFC 398]. Further, the URI(s) in the request are tokenized based on “@”, “/” or “.” and delimiters can be processed from left to right as they follow hierarchical naming scheme. In an embodiment, the URI of each agent consists of the agent identifier or the agent role, and the society identifier. In case of the role then there can be additional fragment of attributes attached with the URI. These fragments further help for filtering. In an embodiment, the user agent 102₁ header of the request also includes the URI for the user agent 102₁ following the same format as any other agent URI.

At step 208, the discovery agent 106₁ determines whether the service agent 110 is available in the default society. In an embodiment, the discovery process is based on filters. Each filter is a probabilistic set of agent membership. Each set belong to one or more tokens of the URI. The discovery happens starting from highest to lowest precedence of the tokens until a single set is found for the agent. The precedence from highest to lowest is as follows:
i. Agent Society: The host name (optionally with port id) in authority.
ii. Agent Role: The user information part of authority or query parameters or path.
iii. Agent Id: The user information part of authority or query parameters.
iv. Agent attributes: query parameters.
v. Agent Fragment: Fragment.

Further, the default society includes hierarchical (i.e., n-array) tree structure of filters, each of them representing one society. At the end of traversal, matching societies can be processed further.

At step 210, the discovery agent 106₁ forwards the request to other discovery agent 106₂ to discover the location of the service agent 110₁ in other society after determining that the service agent 110 is unavailable in the default society. In an embodiment, the discovery agent 106₁ can communicate with the other discovery agent 106₂ in the society 104 by forwarding an original request. The other discovery agent 106₂ can perform the search to find the exact agent instance using the agent role, the agent identifier, the agent attribute, and the agent fragment. All of the tokens have hierarchical probabilistic sets and the searching is done in descending order of precedence. Once the service agent 110₁ instance is found, a reference, which is the URL of the service agent 110₁, is returned back to the requesting discovery agent 106₁.

At step 212, after receiving the request, the other discovery agent 106₂ determines whether the service agent 110₁ is available in the other society.

At step 214, the other discovery agent 106₂ can be configured to discover the location of the service agent 110₁ in the other society. Further, the other discovery agent 106₂ can be configured to send the URL and the connection token of the service agent 110₁ to the discovery agent 106₁ after determining the location of the service agent 110₁ in the other society.

At step 216, the discovery agent 106₁ forwards the received URL and the connection token of the service agent 110₁ to the user agent 102₁. In an embodiment, the discovery agent 106₁ in the default society can be configured to send the service agent 110₁ location discovery response to the user agent 102₁ with the detected URL(s). The response can have more than one URL in case of agent role based discovery. The user agent 102₁ contacts them sequentially or concurrently. The response includes the connection token, which can be used to contact any connection agent 108₁ or specific in the requested societies.

At step 218, the user agent 102₁ can be configured to send the connection request including the URL and the connection token to the connection agent 108₁ in the other society where the service agent 110₁ is located. In an embodiment, the user agent 102₁ sends the HTTP agent connection request, which includes connection token to the connection agent 108₁ in the other society.

At step 220, after receiving the connection request, the connection agent 108₁ can be configured to validate the connection token. At step 222, the connection agent 108₁ can be configured to send the accept connection request to the service agent 110₁. At step 224, the service agent 110₁ can be configured to accept connection response to the connection agent 108₁. At step 226, the connection agent 108₁ can be configured to send the request to the user agent 102₁ to connect with the service agent 110₁. At step 228, the user agent 102₁ can be configured to establish the connection with the service agent 110₁.

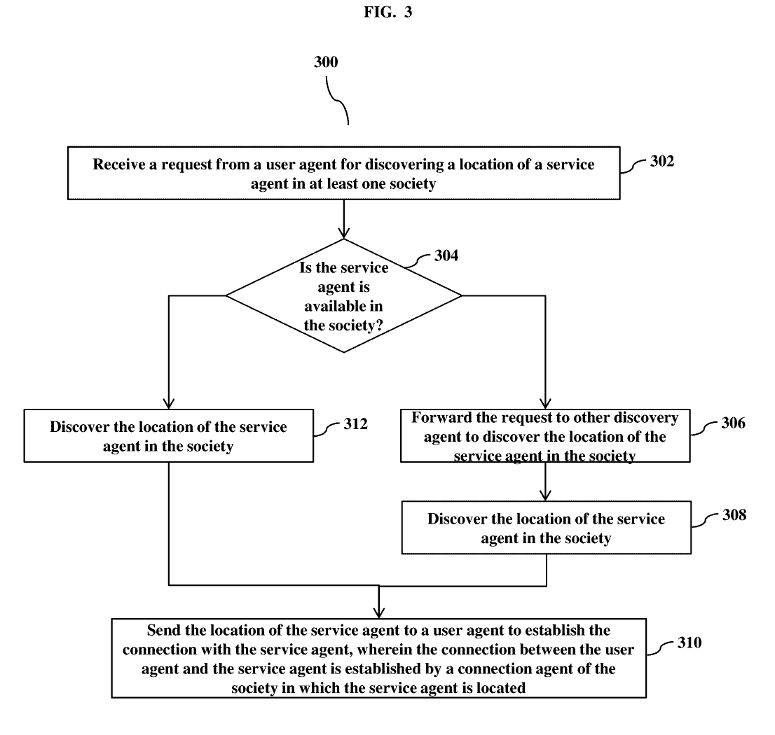

FIG. 3 is a flow diagram illustrating a method 300 for federated service agent discovery in the pervasive device management system 100, according to embodiments as disclosed herein. At step 302, the method 300 includes receiving the request from the user agent 102₁ for discovering the location of the service agent 110 in at least one society. The method 300 allows the discovery agent 106 to receive the request from the user agent 102₁ for discovering the location of the service agent 110 in the society 104.

If it is determined, at step 304, that the service agent 110 is unavailable in the society 104 then, at step 306, the method 300 includes forwarding the request to the other discovery agent 106₁ to discover the location of the service agent 110₁ in the society 104. The method 300 allows the discovery agent 106 to forward the request to the other discovery agent 106₁ to discover the location of the service agent 110₁ in the society 104. At step 308, the method 300 includes discovering the location of the service agent 110₁ in the society 104. The method 300 allows the other discovery agent 106₁ to discover the location of the service agent 110₁ in the society 104. At step 310, the method 300 includes sending the location of the service agent 110₁ to the user agent 102₁ to establish the connection with the service agent 110₁. The connection between the user agent 102₁ and the service agent 110₁ is established by the connection agent 108₁ of the society 104 where the service agent 110₁ is located.

If it is determined, at step 304, that the service agent 110 is available in the society 104 then, at step 312, the method 300 allows the discovery agent 106 to discover the location of the service agent 110 in the society 104 and step 310 is performed as described above. The method 300 allows the discovery agent 106 to discover the location of the service agent 110 in the society 104 and step 310 is performed as described above.

The various actions units, steps, blocks, or acts described in the method 300 may be performed in the order presented, in a different order, or simultaneously. Further, in some embodiments, some of the actions, units, steps, blocks, or acts listed in the FIG. 3 may be omitted, added, skipped, or modified without departing from the scope of the invention.

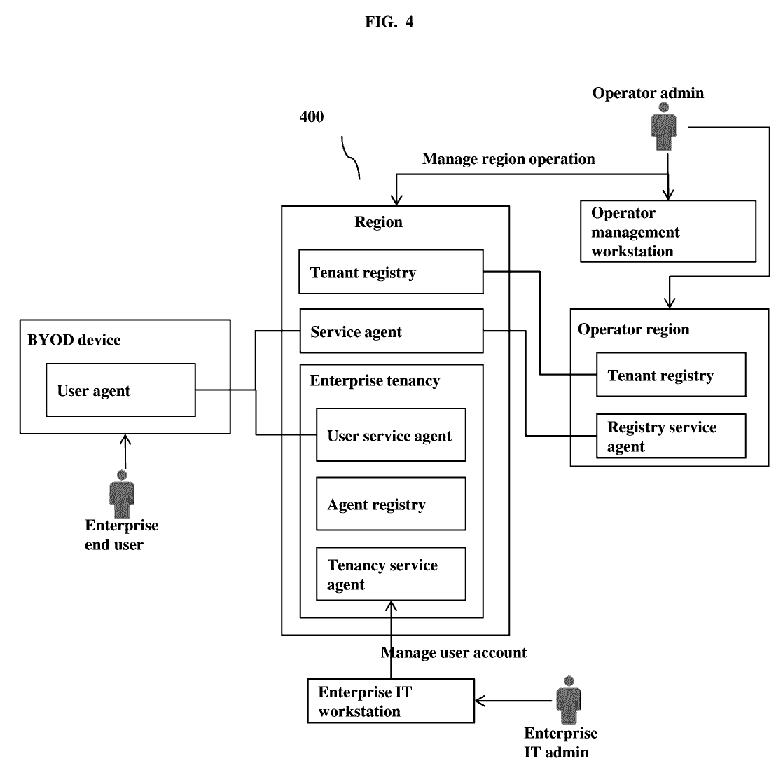

FIG. 4 shows example illustrations for Mobile Enterprise Stack Device Management (MES DM) services region specific registries and agents, according to embodiments as disclosed herein. The MES DM service includes many regions and each region is an agent society. Each of these regions can be categorized by different ontologies. In an example, some regions are categorized based on geography, some regions are categorized by the service delivery operator, and some are categorized by infrastructure, and so on. There can be any number of categorizations possible.

Further, each region (i.e., the society) includes three types of service agents such as a registry service agent, an enterprise tenancy service agent and an enterprise user service agent. The registry service agent is the default society discovery agent (i.e., pass 1). The enterprise tenancy service agent plays role of discovery (i.e., pass 2) and connection agent. The user service agent handles collaborations with the user agent.

Each region maintains enterprise tenant registry with known enterprises. When new enterprise tenancy is added to MES DM Service region then that region's registry service agent broadcasts messages to all other registry service agent to synchronize their registries. Each region specific registry further responds with their updated bloom filters. This is done as a periodic synchronization process. Note: Synchronization is policy based. In other words, the enterprise IT Admin can control which regions to synchronize.

Each enterprise tenancy in the region also maintains the user service agent registry identified by user id. When new user is added to enterprise database then corresponding entry is added to the enterprise specific registry. Again this registry is a bloom filter set.

When the user agent on the mobile device connects to nearest default region and passes the user id of the enterprise end, user agent can then performs discovery process using the registry service—pass 1, to find the enterprise tenancy specific region.

The registry service agent can send the request to tenancy service agent to find the user agent for that user.

The tenancy service agent performs discovery process—pass 2 and finds the user in the registry. It sends the URL of the found user back to registry service, which can then send that back to user agent on the device.

After this the user agent can directly contact the user service agent on the KDM Service cloud. Note: In cases of 3rd party Software as a Service (SaaS) providers or on device P2P services, the user service agents can be provided by them. However, the user service agents they belong to same society. Also, in some cases like 3rd party SaaS services will be aggregated by the MES DM Device Management Services and such services will be represented (i.e. by proxy) by the user service agent within the region. In all these case discovery process remains the same and invisible to end-user.

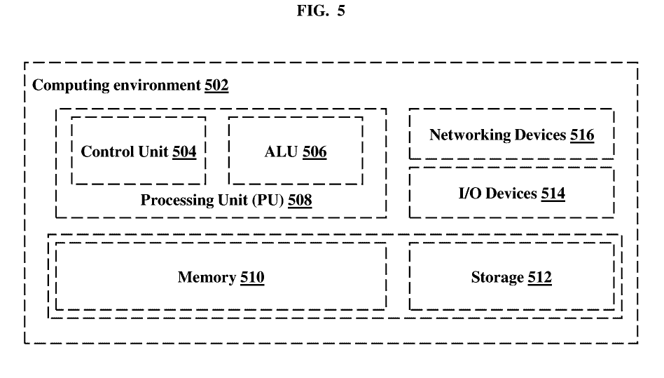

FIG. 5 illustrates a computing environment 502 implementing the method and systems as disclosed in the embodiments herein. As depicted the computing environment 502 comprises at least one processing unit 508 that is equipped with a control unit 504 and an Arithmetic Logic Unit (ALU) 506, a memory 510, a storage unit 512, plurality of networking devices 516 and a plurality Input output (I/O) devices 514. The processing unit 508 is responsible for processing the instructions for federated service agent discovery in the pervasive device management system. The processing unit 508 receives commands from the control unit 504 in order to perform its processing. Further, any logical and arithmetic operations involved in the execution of the instructions are computed with the help of the ALU 506.

The overall computing environment 502 can be composed of multiple homogeneous or heterogeneous cores, multiple CPUs of different kinds, special media and other accelerators. Further, the plurality of processing units 508 may be located on a single chip or over multiple chips.

The technique comprising of instructions and codes required for the implementation are stored in either the memory unit 510 or the storage 512 or both. At the time of execution, the instructions may be fetched from the corresponding memory 510 or storage 512, and executed by the processing unit 508.

In case of any hardware implementations various networking devices 516 or external I/O devices 514 may be connected to the computing environment to support the implementation through the networking unit and the I/O device unit.

The embodiments disclosed herein can be implemented through at least one software component running on at least one hardware device and performing network management functions to control the network elements. The elements shown in the FIGS. 1-5 include blocks which can be at least one of a hardware device, or a combination of hardware device and software components.

The embodiment disclosed herein specifies a system and method for presenting context-oriented content from a plurality of information sources. The mechanism can automatically make decisions on appropriate services used by the user and generate aggregated bill for the user. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with Application programming interfaces (APIs) and software techniques written in e.g. Very high speed integrated circuit Hardware Description Language (VHDL), XML (Extensible Markup Language), Asynchronous JavaScript and XML (AJAX), or an equivalent thereof. Several software components being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for federated service agent discovery in a pervasive device management system, the method comprising:
receiving, by a discovery agent, a request from a user agent for discovering a location of a service agent in at least one society; and
discovering, by said discovery agent, said location of said service agent in at least one said society to establish a connection between said user agent and said service agent, wherein said location of said service agent is federately discovered by said discovery agent by communicating with other discovery agents in said society.

2. The method of claim 1, wherein federately discovering, by said discovery agent, said location of said service agent in at least one said society comprising:
determining, said discovery agent, whether said service agent is available in at least one said society;
forwarding said request to other discovery agent to discover said location of said service agent in at least one said society in response to determining by said discovery agent that said service agent is unavailable in at least one said society; and
discovering, by said other discovery agent, said location of said service agent in at least one said society.

3. The method of claim 1, wherein said method further comprises:
sending, by said discovery agent, said location of said service agent to said user agent to establish said connection with said service agent, wherein said connection between said user agent and said service agent is established by a connection agent of said society in which said service agent is located.

4. The method of claim 1, wherein said connection between said user agent and said service agent is used to communicate with other service agents in at least one said society.

5. The method of claim 4, wherein said connection is handed over to support multi agents support in at least one said society.

6. The method of claim 4, wherein said connection is cloned to support multi agent's support in at least one said society.

7. The method of claim 1, wherein said service agent is associated with a service agent identifier to discover said location in at least one said society.

8. The method of claim 1, wherein said request comprises at least one of a service agent identifier, a discovery agent identifier, and a society identifier.

9. The method of claim 1, wherein said society is formed by said user agent, said discovery agent, said service agent and said connection agent, wherein all said agents are sharing a common ontology.

10. The method of claim 9, wherein said ontology comprises information of at least one of geographic location, enterprise tenancy, service type, choreographies, and trust zone.

11. The method of claim 9, wherein said society is composed of other sub-societies.

12. A discovery agent for federated service agent discovery pervasive device management system, the discovery agent configured to:
receive a request from a user agent to discover a location of a service agent in at least one society; and
discover said location of said service agent in at least one said society to establish a connection between said user agent and said service agent, wherein said location of said service agent is federately discovered by communicating with other discovery agents in at least one said society.

13. The discovery agent of claim 12, wherein said federated discovery of said location of said service agent in at least one said society comprising:
determine whether said service agent is available in at least one said society;
forward said request to other discovery agent to discover said location of said service agent in at least one said society in response to determining by said discovery agent that said service agent is unavailable in at least one said society; and
discover, by said other discovery agent, said location of said service agent in at least one said society.

14. The discovery agent of claim 12, wherein said discovery agent further configured to:
send said location of said service agent to said user agent to establish said connection with said service agent, wherein said connection between said user agent and said service agent is established by a connection agent of said society in which said service agent is located.

15. The discovery agent of claim 12, wherein said connection between said user agent and said service agent is used to communicate with other service agents in at least one said society.

16. The discovery agent of claim 15, wherein said connection is handed over to support multi agent's support in at least one said society.

17. The discovery agent of claim 15, wherein said connection is cloned to support multi agent's support in at least one said society.

18. The discovery agent of claim 12, wherein said service agent is associated with a service agent identifier to discover said location in at least one said society.

19. The discovery agent of claim 12, wherein said request comprises at least one of a service agent identifier, a discovery agent identifier, and a society identifier.

20. The discovery agent of claim 12, wherein said society is formed by said user agent, said discovery agent, said service agent and said connection agent, wherein all said agents are sharing a common ontology.

21. The discovery agent of claim 20, wherein said ontology comprises information of at least one of geographic location, enterprise tenancy, service type, choreographies, and trust zone.

22. The discovery agent of claim 20, wherein said society is composed of other sub-societies.

23. A pervasive device management system for federated service agent discovery, the pervasive device management system comprising:
a user agent;
a discovery agent configured to:
receive a request from said user agent to discover a location of a service agent in at least one society; and
discover said location of said service agent in at least one said society, wherein said location of said service agent is federately discovered by communicating with other discovery agents in at least one said society; and
a connection agent configured to establish a connection between said user agent and said service agent.

24. The pervasive device management system of claim 23, wherein said federated discovery of said location of said service agent in at least one said society comprising:
determine, by said discovery agent, whether said service agent is available in at least one said society;
forward said request to other discovery agent to discover said location of said service agent in at least one said society in response to determining by said discovery agent that said service agent is unavailable in at least one said society; and
discover, by said other discovery agent, said location of said service agent in at least one said society.

25. The pervasive device management system of claim 23, wherein said connection agent corresponds to of said in which said user agent is located.

26. The pervasive device management system of claim 23, wherein said connection between said user agent and said service agent is used to communicate with other service agents in at least one said society.

27. The pervasive device management system of claim 26, wherein said connection is handed over to support multi agent's support in at least one said society.

28. The pervasive device management system of claim 26, wherein said connection is cloned to support multi agent's support in at least one said society.

29. The pervasive device management system of claim 26, wherein said service agent is associated with a service agent identifier to discover said location in at least one said society.

30. The pervasive device management system of claim 26, wherein said request comprises at least one of a service agent identifier, a discovery agent identifier, and a society identifier.

31. The pervasive device management system of claim 26, wherein said society is formed by said user agent, said discovery agent, said service agent and said connection agent, wherein all said agents are sharing a common ontology.

32. The pervasive device management system of claim 31, wherein said ontology comprises information of at least one of geographic location, enterprise tenancy, service type, choreographies, and trust zone.

33. The pervasive device management system of claim 31, wherein said society is composed of other sub-societies.
